(19) United States
(12) Patent Application Publication
(10) Pub. No.: US 2020/0280435 A1
(43) Pub. Date: Sep. 3, 2020

(54) Secure Authentication in a 5G Communication Network in Non-3GPP Access

(71) Applicant: Telefonaktiebolaget LM Ericsson (publ), Stockholm (SE)

(72) Inventors: Vesa LEHTOVIRTA, ESPOO (FI); Jari ARKKO, KAUNIAINEN (FI)

(21) Appl. No.: 16/759,966

(22) PCT Filed: Oct. 3, 2018
(86) PCT No.: PCT/EP2018/076917

§ 371 Date: Apr. 28, 2020

Related U.S. Application Data
(60) Provisional application No. 62/585,008, filed on Nov. 13, 2017.

(51) Int. Cl. H04L 9/08; H04L 29/06; H04W 12/04; H04W 12/00

(52) U.S. Cl. CPC H04L 9/0822; H04L 63/061; H04W 12/04031; H04W 12/003; H04W 12/0401

(57) ABSTRACT

The present invention relates to a method for secure authentication in a communication network. The method is performed in a user equipment, UE, and comprises providing (S100) an inner authentication key by an inner authentication process, deriving (S110) an outer authentication key by an outer authentication process, based on the inner authentication key, wherein the outer authentication key differs from the inner authentication key, and providing (S120) the derived outer authentication key to a security protocol/for subsequent, secure communication. A method, user equipments, network nodes, 5G core networks, computer programs, and a computer program product for secure authentication in a communication network are also presented.

### TECHNICAL FIELD

The invention relates to methods for secure authentication in a communication network, a user equipment, a network node and a 5G core network for secure authentication in a communication network, and corresponding computer programs and computer program product.

### BACKGROUND

The 3rd Generation Partnership Project (3GPP) is specifying the 5G registration procedures in technical specification (TS) 23.501 and 23.502. The security aspects are being specified in TS 33.501.

The current solution for registration over non-3GPP access is specified in meeting contribution document (TDoc) S2-177794 (it will be included in TS 23.502 clause 4.12.2). It is expected that more security details will be specified in TS 33.501. Especially, the TDoc describes the use of two nested Extensible Authentication Protocol (EAP) processes, EAP-5G and EAP-Authentication and Key Agreement (AKA′).

Clause 4.12.2 from S2-17794—Registration via Untrusted non-3GPP Access specifies how a user equipment (UE) can register to 5G core (5GC) network via an untrusted non-3GPP access network. It is based on the registration procedure specified in clause 4.2.2.2.2 and it uses a vendor-specific EAP process called EAP-5G. The EAP-5G packets utilize the expanded EAP type and the existing 3GPP Vendor-Id registered with IANA under the Structure of Management Information (SMI) Private Enterprise Code registry. The EAP-5G process is used between the UE and the Non-3GPP Interworking Function (N3IWF) and is utilized only for encapsulating Non-Access Stratum (NAS) messages (not for authentication). If the UE needs to be authenticated, an EAP-AKA′ mutual authentication is executed between the UE and Authentication Server Function (AUSF) as shown below. The details of the EAP-AKA′ authentication procedure are specified in TS 33.501.

In registration and subsequent registration procedures via untrusted non-3GPP access, the NAS messages are always exchanged between the UE and the AMF. When possible, the UE can be authenticated by reusing the existing UE security context in authentication management function (AMF).

FIG. 4.12.2-1 from TS 23.502 is shown in FIG. 1, showing registration via untrusted non-3GPP access.

1. The UE connects to an untrusted non-3GPP access network with procedures outside the scope of 3GPP and it is assigned an IP address. Any non-3GPP authentication method can be used, e.g. no authentication (in case of a free Wireless Local Area Network (WLAN)), EAP with pre-shared key, username/password, etc. When the UE decides to attach to 5GC network, the UE selects an N3IWF in a 5G public land mobile network (PLMN), as described in TS 23.501 clause 6.3.6.

2. The UE proceeds with the establishment of an IPsec Security Association (SA) with the selected N3IWF by initiating an Internet Key Exchange (IKE) initial exchange according to request for comments (RFC) 7296. After step 2 all subsequent IKE messages are encrypted and integrity protected by using the IKE SA established in this step.

3. The UE shall initiate an IKE_AUTH exchange by sending an IKE_AUTH request message. The AUTH payload is not included in the IKE_AUTH request message, which indicates that the IKE_AUTH exchange shall use EAP signalling (in this case EAP-5G signalling).

4. The N3IWF responds with an IKE_AUTH response message which includes an EAP-Request/5G-Start packet. The EAP-Request/5G-Start packet informs the UE to initiate an EAP-5G session, i.e. to start sending NAS messages encapsulated within EAP-5G packets.

5. The UE shall send an IKE_AUTH request which includes an EAP-Response/5G-NAS packet that contains the Access Network parameters (AN-Params) defined in clause 4.2.2.2.2 and a NAS Registration Request message.

The AN-Params contain information (e.g. Subscriber Permanent Identifier (SUPI) or 5G—Globally Unique Temporary Identity (ID) (GUTI), the Selected Network and Network Slice Selection Assistance Information (NSSAI)) that is used by the N3IWF for selecting an AMF in the 5G core network.

The N3IWF does however not send an EAP-Identity request because the UE includes its identity in the first IKE AUTH. This is in line with RFC7296, clause 3.16.

6. The N3IWF shall select an AMF based on the received AN-Params and local policy, as specified in TS 23.501, clause 6.5.3. The N3IWF shall then forward the NAS Registration Request received from the UE to the selected AMF.

7. The selected AMF may decide to request the UE's permanent identity (SUPI) by sending a NAS Identity Request message to UE. This NAS message and all subsequent NAS messages are sent to UE encapsulated within EAP/5G-NAS packets. The SUPI provided by the UE shall be encrypted as specified in TS 33.501.

8. The AMF may decide to authenticate the UE. In this case, the AMF shall select an AUSF as specified in TS 23.501 clause 6.3.4 by using the SUPI or the encrypted SUPI of the UE, and shall send a key request to the selected AUSF. The AUSF may initiate an EAP-AKA′ authentication as specified in TS 33.501. The EAP-AKA′ packets are encapsulated within NAS authentication messages and the NAS authentication messages are encapsulated within EAP/5G-NAS packets. After the successful authentication:
In step 8h, the AUSF shall send the anchor key (security anchor function (SEAF) key) to AMF which is used by AMF to derive NAS security keys and a security key for N3IWF (N3IWF key). The UE also derives the anchor key (SEAF key) and from that key it derives the NAS security keys and the security key for N3IWF (N3IWF key). The N3IWF key is used by the UE and N3IWF for establishing the IPsec Security Association (in step 11).

1 In step 8h, the AUSF shall also include the SUPI (unencrypted), if in step 8a the AMF provided to AUSF an encrypted SUPI.

Only EAP-AKA′ is however supported for the authentication of UE via non-3GPP access, as specified in TS 33.501.

9. The AMF shall send a Security Mode Command (SMC) request to UE in order to activate NAS security. This request is first sent to N3IWF (within an N2 message) together with the N3IWF key. If an EAP-AKA′ authentication was successfully executed in step 8, then in step 9a the AMF shall encapsulate the EAP-Success received from AUSF within the SMC Request message.

10. The UE completes the EAP-AKA′ authentication (if initiated in step 8) and creates a NAS security context and an N3IWF key. After the N3IWF key is created in the UE, the UE shall request the completion of the EAP-5G session by sending an EAP-Response/5G-Complete packet. This triggers the N3IWF to send an EAP-Success to UE, assuming the N3IWF has also received the N3IWF key from AMF. This completes the EAP-5G session and no further EAP-5G packets are exchanged. If the N3IWF has not received the N3IWF key from AMF, the N3IWF shall respond with an EAP-Failure.

11. The IPsec SA is established between the UE and N3IWF by using the common N3IWF key that was created in the UE and was received by N3IWF in step 9a. This IPsec SA is referred to as the “signalling IPsec SA”. After the establishment of the signalling IPsec SA all NAS messages between the UE and N3IWF are exchanged via this SA. The signalling IPsec SA shall be configured to operate in transport mode. The S Security Parameters Indication (PI) value is used to determine if an IPsec packet carries a NAS message or not.

It is however for further study if Generic Routing Encapsulation (GRE) or any other protocol is needed for the encapsulation of NAS messages.

12. The UE shall send the SMC Complete message over the established signalling IPsec SA and all subsequent NAS messages (as specified in clause 4.2.2.2.2) are exchanged between the UE and AMF via this IPsec SA.

### SUMMARY

It is an object of the invention to enable improved security in authentication in a communication network.

According to a first aspect, there is presented a method for secure authentication in a communication network. The method is performed in a user equipment (UE) and comprises providing an inner authentication key by an inner authentication process, deriving an outer authentication key by an outer authentication process, based on the inner authentication key, wherein the outer authentication key differs from the inner authentication key, and providing the derived outer authentication key to a security protocol/for subsequent, secure communication.

The outer authentication process may be an Extensible Authentication Protocol (EAP) process, such as EAP-5G, and the inner authentication process may be an EAP process, such as EAP-Authentication and Key Agreement (AKA) or EAP-AKA′.

The outer authentication process may be EAP-5G and the inner authentication process may be integrity protected message, such as a Non-Access Stratum (NAS) message.

The deriving may be performed with a hash function of the inner authentication key or a derivative of the inner authentication key. The hash function may use the inner authentication key and other material. The other material may be a string or a freshness parameter, such as a counter or a nonce.

The outer authentication process may rely on a key solely from the inner authentication process.

According to a second aspect, there is presented a method for secure authentication in a communication network. The method is performed in a network node and comprises providing an inner authentication key by an inner authentication process, deriving an outer authentication key by an outer authentication process, based on the inner authentication key, wherein the outer authentication key differs from the inner authentication key, and providing the derived outer authentication key to a security protocol/for subsequent, secure communication.

The outer authentication process may be an EAP process, such as EAP-5G, to and the inner authentication process may be an EAP process, such as EAP-AKA or EAP-AKA′.

The outer authentication process may be an EAP process, such as EAP-5G, and the inner authentication process may be an integrity protected message, such as a NAS message.

The deriving may be performed with a hash function of the inner authentication key or a derivative of the inner authentication key. The hash function may use the inner authentication key and other material. The other material may be a string or a freshness parameter, such as a counter or a nonce.

The method outer authentication process may rely on a key solely from the inner authentication process.

The network node may be an authentication management function (AMF)/security anchor function (SEAF) or a Non-3GPP Interworking Function (N3IWF) or an Authentication Server Function (AUSF) or a gNodeB.

According to a third aspect, there is presented a method for secure authentication in a communication network. The method is performed in a 5G core (5GC) network and comprises providing an inner authentication key by an inner authentication process in an AMF/SEAF, deriving an outer authentication key by an outer authentication process in a N3IWF, based on the inner authentication key provided in AMF/SEAF, wherein the outer authentication key differs from the inner authentication key, and providing the derived outer authentication key to a security protocol/for subsequent, secure communication.

According to a fourth aspect, there is presented a UE for secure authentication in a communication network. The UE comprises a processor, and a computer program product storing instructions that, when executed by the processor, causes the UE to provide an inner authentication key by an to inner authentication process, to derive an outer authentication key by an outer authentication process, based on the inner authentication key, wherein the outer authentication key differs from the inner authentication key, and to provide the derived outer authentication key to a security protocol/for subsequent, secure communication.

According to a fifth aspect, there is presented a network node for secure authentication in a communication network. The network node comprises a processor, and computer program product storing instructions that, when executed by the processor, causes the network node to provide an inner authentication key by an inner authentication process, to derive an outer authentication key by an outer authentication process, based on the inner authentication key, wherein the outer authentication key differs from the inner authentication key, and to provide the derived outer authentication key to a security protocol/for subsequent, secure communication.

According to a sixth aspect, there is presented a 5GC network for secure authentication in a communication network. The 5GC network comprises a processor, and a computer program product storing instructions that, when executed by the processor, causes the 5GC network to provide an inner authentication key by an inner authentication process in an AMF/SEAF, to derive an outer authentication key by an outer authentication process in a N3IWF, based on the inner authentication key provided in AMF/SEAF, wherein the outer authentication key differs from the inner authentication key, and to provide the derived outer authentication key to a security protocol/for subsequent, secure communication.

According to a seventh aspect, there is presented a UE for secure authentication in a communication network. The UE comprises a determination manager for providing an inner authentication key by an inner authentication process and for deriving an outer authentication key by an outer authentication process, based on the inner authentication key, wherein the outer authentication key differs from the inner authentication key, and a communication manager for providing the derived outer authentication key to a security protocol/for subsequent, secure communication.

According to an eighth aspect, there is presented a network node for secure authentication in a communication network. The network node comprises determination manager for providing an inner authentication key by an inner authentication process and for deriving an outer authentication key by an outer authentication process, based on the inner authentication key, wherein the outer authentication key differs from the inner authentication key, and a communication manager for providing the derived outer authentication key to a security protocol/for subsequent, secure communication.

According to a ninth aspect, there is presented a 5GC network for secure authentication in a communication network. The 5GC network comprises a determination manager for providing an inner authentication key by an inner authentication process in an AMF/SEAF, and for deriving an outer authentication key by an outer authentication process in an N3IWF, based on the inner authentication key provided in AMF/SEAF, wherein the outer authentication key differs from the inner authentication key, and a communication manager for providing the derived outer authentication key to a security protocol/for subsequent, secure communication.

According to a tenth aspect, there is presented a computer program for secure authentication in a communication network. The computer program comprising computer program code which, when run on a UE, causes the UE to provide an inner authentication key by an inner authentication process, to derive an outer authentication key by an outer authentication process, based on the inner authentication key, wherein the outer authentication key differs from the inner authentication key, and to provide the derived outer authentication key to a security protocol/for subsequent, secure communication.

According to an eleventh aspect, there is presented a computer program for secure authentication in a communication network. The computer program comprising computer program code which, when run on a network node, causes the network node to provide an inner authentication key by an inner authentication process, to derive an outer authentication key by an outer authentication process, based on the inner authentication key, wherein the outer authentication key differs from the inner authentication key, and to provide the derived outer authentication key to a security protocol/for subsequent, secure communication.

According to a twelfth aspect, there is presented a computer program for secure authentication in a communication network. The computer program comprising computer program code which, when run on a 5G network, causes the 5GC network to provide an inner authentication key by an inner authentication process in an AMF/SEAF, to derive an outer authentication key by an outer authentication process in an N3IWF, based on the inner authentication key provided in AMF/SEAF, wherein the outer authentication key differs from the inner authentication key, and to provide the derived outer authentication key to a security protocol/for subsequent, secure communication.

A computer program product comprising a computer program and a computer readable storage means on which the computer program is stored is also presented.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a signalling diagram illustrating registration via untrusted non-3GPP access;

FIG. 2 schematically illustrates protocol stacks for using EAG-5G over non-3GPP registration to SGC;

FIG. 3 is a signalling diagram illustrating 5G registration with the EAP-5G protocol, full authentication;

FIG. 4 schematically illustrates protocol stacks for using EAG-5G over non-3GPP registration to 5GC according to an embodiment presented herein;

FIG. 5 schematically illustrates protocol stacks for using EAG-5G over non-3GPP registration to 5GC according to an embodiment presented herein;

FIG. 6 schematically illustrates protocol stacks for using EAG-5G over non-3GPP registration to 5GC according to an embodiment presented herein;

FIG. 7 is a signalling diagram illustrating registration via untrusted non-3GPP access according to an embodiment presented herein;

FIGS. 8-9 are flow charts illustrating methods according to embodiments presented herein;

FIGS. 10-11 are schematic diagrams illustrating some components of entities presented herein; and

FIGS. 12-13 are schematic diagrams showing functional modules of embodiments presented herein.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

A more detailed description of the current 3GPP solution is given in TDoc S2-176969. It shows how an EAP process called EAP-5G is performed between the UE and N3IWF. The EAP-5G is used to carry 3GPP NAS signalling, which is performed between the UE and AMF. The NAS may carry another EAP process, e.g. EAP-AKA′ (RFC 5448). If there already exists a security context in the AMF and it can be used to authenticate the UE (i.e. by using an integrity protected NAS message), there may not be a need to run full authentication with EAP-AKA′.

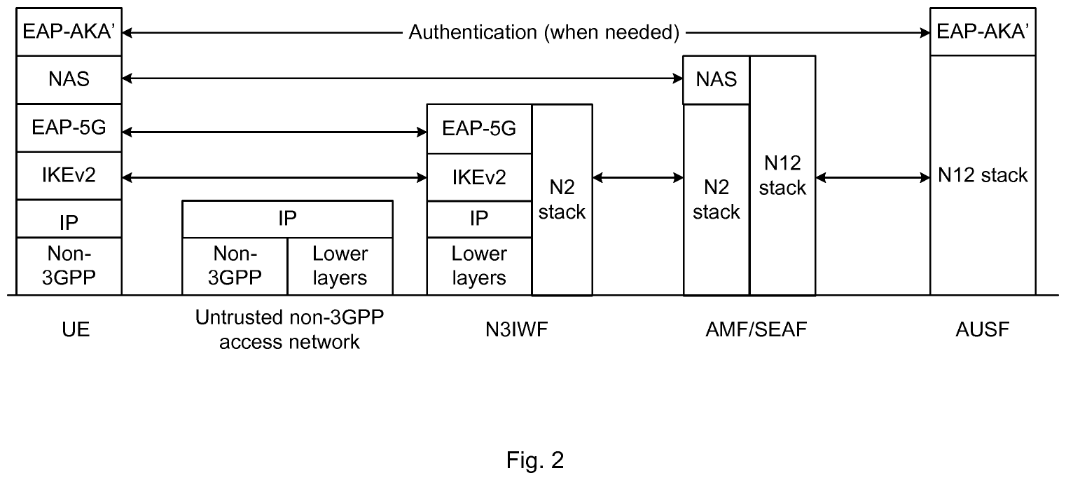

The protocol stack is schematically illustrated in FIG. 2.

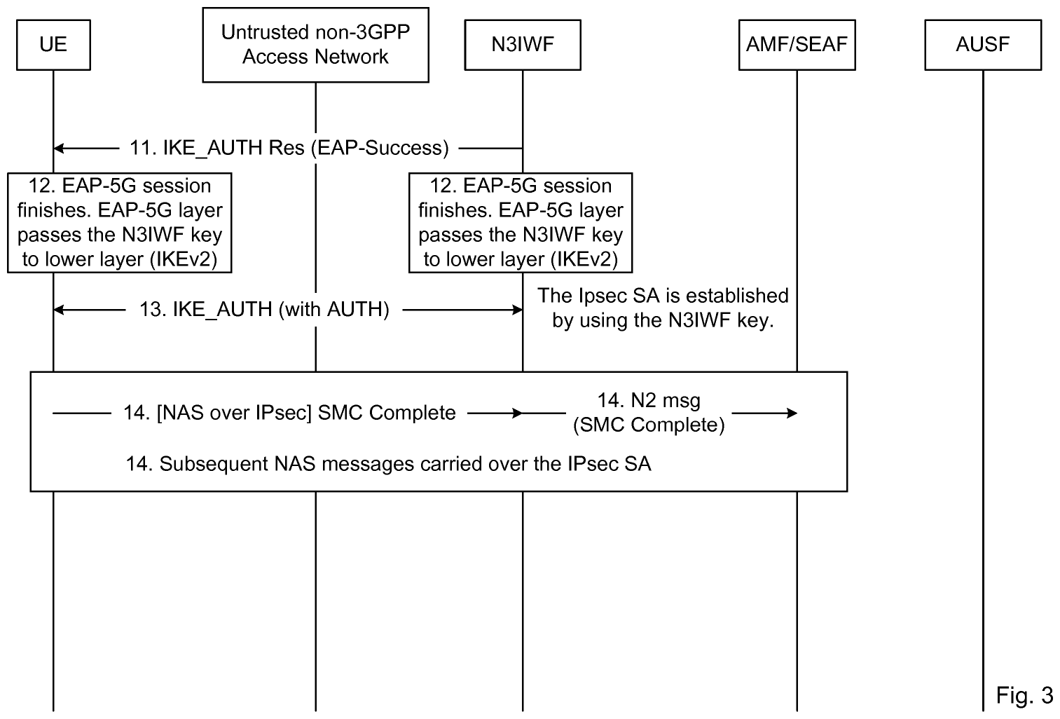

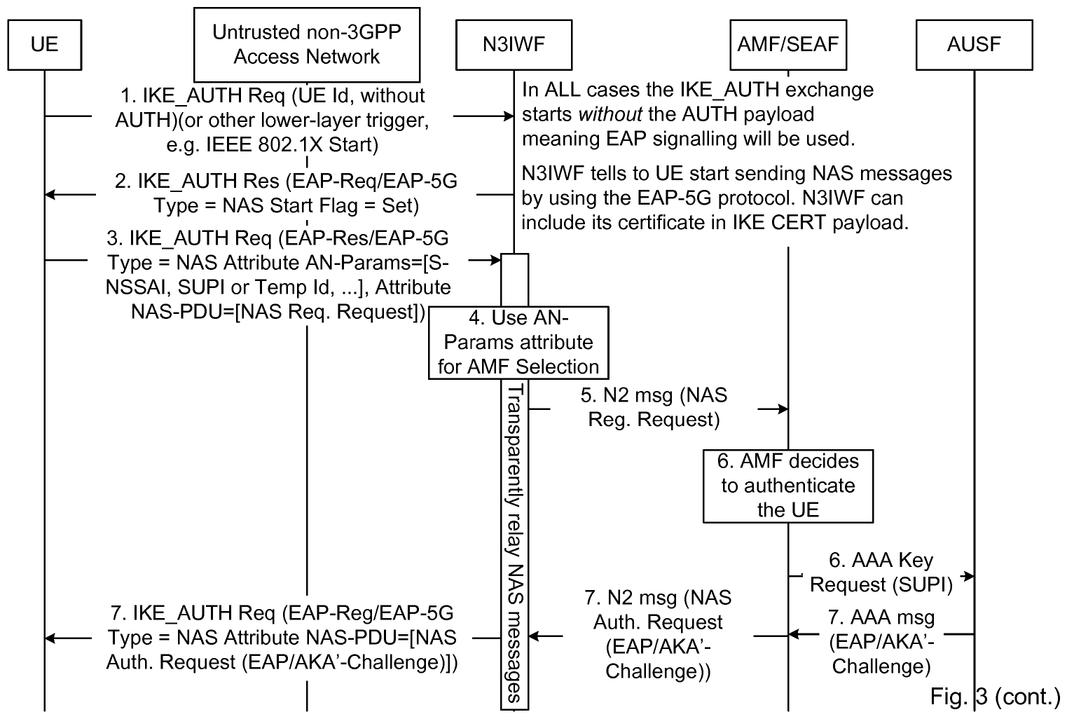

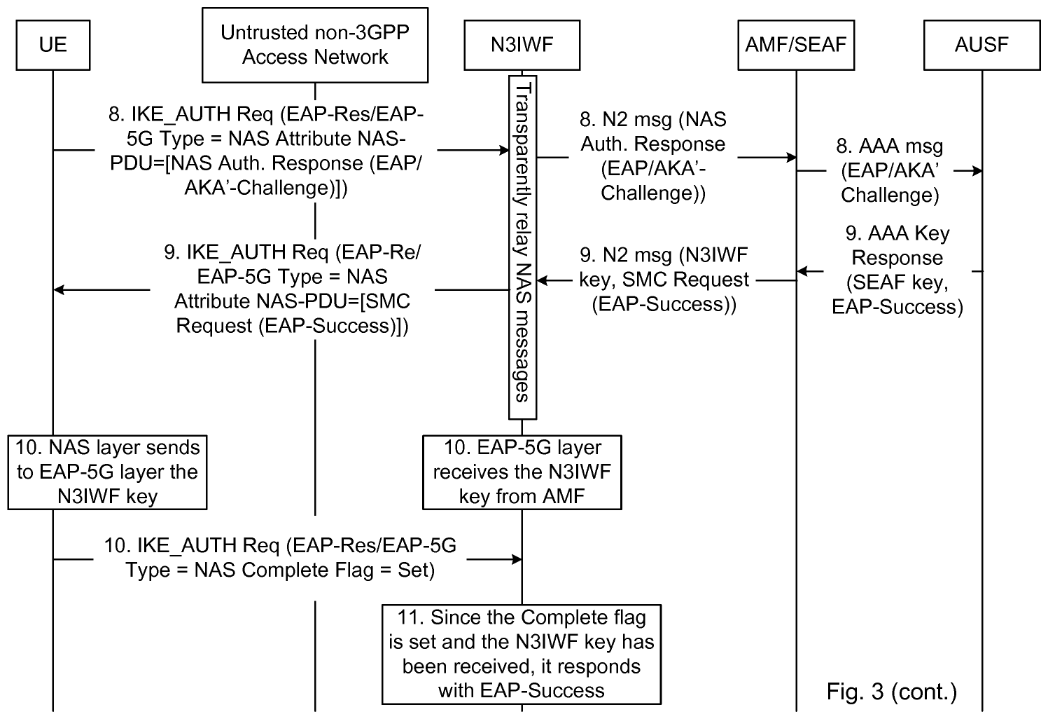

A more detailed flow of running EAP-5G and EAP-AKA′ processes are described in FIG. 3, from TDoc S2-176969.

FIG. 3 shows that EAP-AKA′ produces key material, the so called SEAF key, which is transported to the AMF. The AMF further derives an AMF key (not shown in the figure), which is used to derive a key called N3IWF key. What is of special interest is the way how the N3IWF key is handled. The handling of the N3IWF key is described in TDoc S2-176969 as follows:

The EAP-5G session between the UE and N3IWF is successfully completed when the EAP-5G layer in the UE receives the N3IWF key from the NAS layer, in step 10, and the EAP-5G layer in the N3IWF receives the N3IWF key from AMF, also in step 10. In this case, the UE sends an EAP-5G packet with the Complete flag set, which causes the EAP-5G layer in the N3IWF to send an EAP-Success. After that, the EAP-5G layer in the UE and the EAP-5G layer in the N3IWF forward the common N3IWF key to the lower layer (IKEv2), which is further used for establishing an IPsec security association, step 13. The UE sends the SMC Complete message after the IPsec SA is established, step 14.

It can be observed that the outer authentication process layer, EAP-5G, to receives key material from upper layer, NAS, or another node, AMF, in this case produced by an inner authentication process, EAP-AKA′, which is given as-is to the lower layer, i.e. IKEv2 in this case. The passed key material is not connected to the outer authentication process layer EAP-5G in any way even though EAP-5G is a key producing EAP process from the IKEv2 point of view.

It is a security risk to allow that the same key material is used for different purposes. In this case the same key material is used as a result of two different authentication processes. This leaves unnecessary room for possible future attacks and the discovery of vulnerabilities, e.g., one of the protocol participants lying to the other participants.

It is proposed to connect the key material, which the outer authentication process receives from the inner authentication process, e.g. EAP-AKA′ or NAS, to the outer authentication process, e.g. EAP-5G, before giving it to the security protocol. It should be noted that the inner authentication process can also be the NAS layer if there exists key material in the UE and network produced by an authentication process EAP-AKA′.

It is sufficient that the key between the outer authentication process and the inner authentication process is merely different. The exact way how they are different is not important, even a k=k+1 would suffice. In the general case the outer process key K_{sec} (K_sec in the figures) may be a function of the inner process key, and possibly also of some other material. For instance, the function may be performed in the following way: Ks_{sec}=KDF(N3IWF, “EAP-5G”), where KDF is an appropriate key derivation function such as the KDF as specified in Annex B of 3GPP TS 33.220. This way it is ensured that both communicating sides are ensured which authentication processes were run.

FIGS. 4-6 show some examples how the authentication processes could be implemented in different network nodes in a 5G communication network. Also other implementation variants are possible.

In a general case it is not mandatory to have the NAS layer between different EAP processes, but the inner EAP (i.e. EAP-AKA′) authentication process to may be carried directly over the outer EAP (i.e. EAP-5G) authentication process.

In an embodiment the inner EAP process, the outer EAP process and the NAS are in the same network node, which is illustrated in FIG. 4.

In an embodiment the inner EAP process is in one node, and the outer EAP process and the NAS are in another network node, which is illustrated in FIG. 5.

In an embodiment the inner EAP process, the NAS, and the outer EAP processes are in different network nodes, which is illustrated in FIG. 6.

The presented solution provides good cryptographic hygiene by ensuring that keys, which are used for different purposes, are not literally the same key, and can even be cryptographically separated e.g. via a hash function.

The main benefit of this is that there's less room for potential future attacks and the discovery of vulnerabilities around, e.g., one of the protocol participants lying to the other participants.

The solution is described in the following signalling flow using the relevant parts of current text from S2-177794 as baseline.

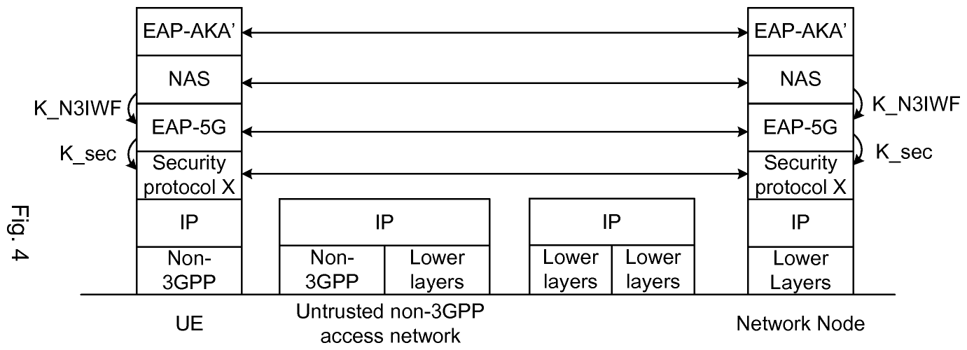

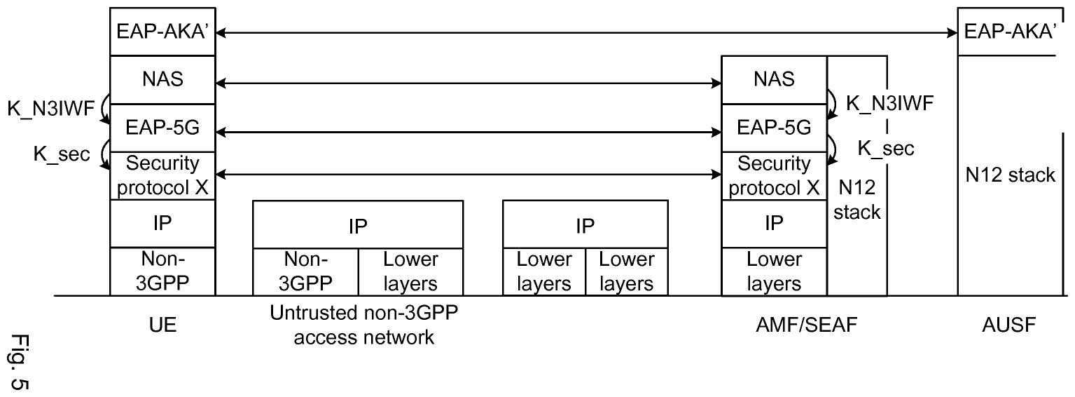

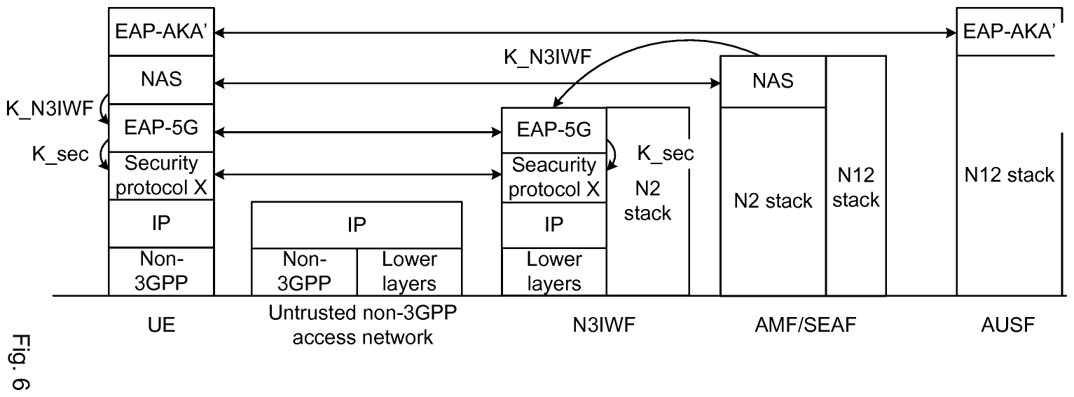

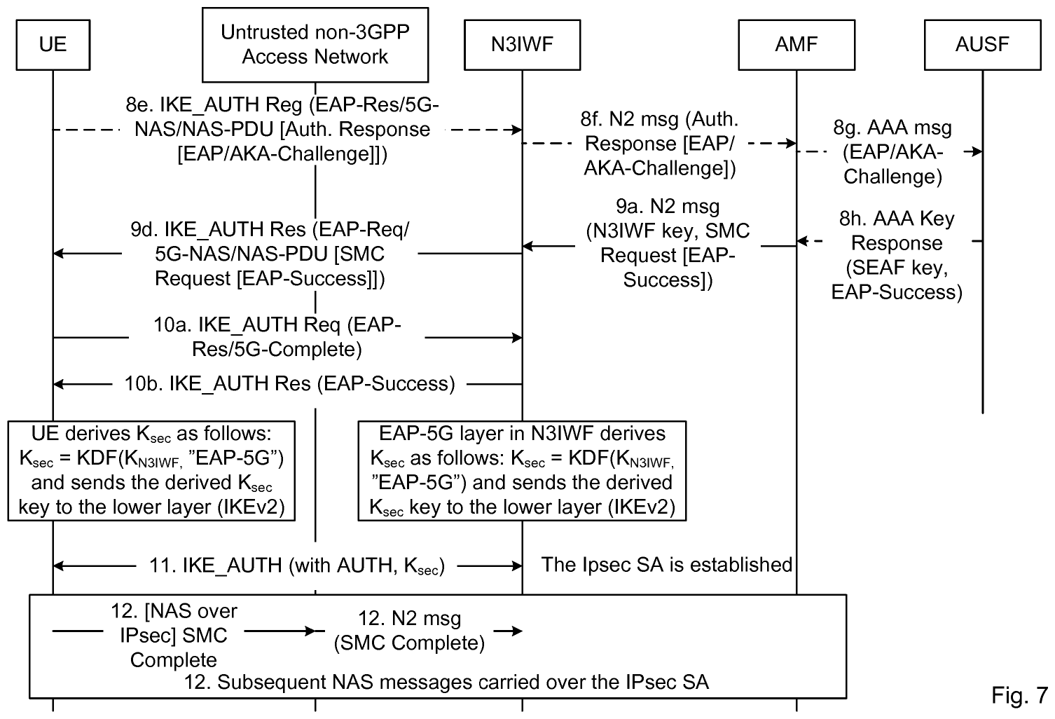

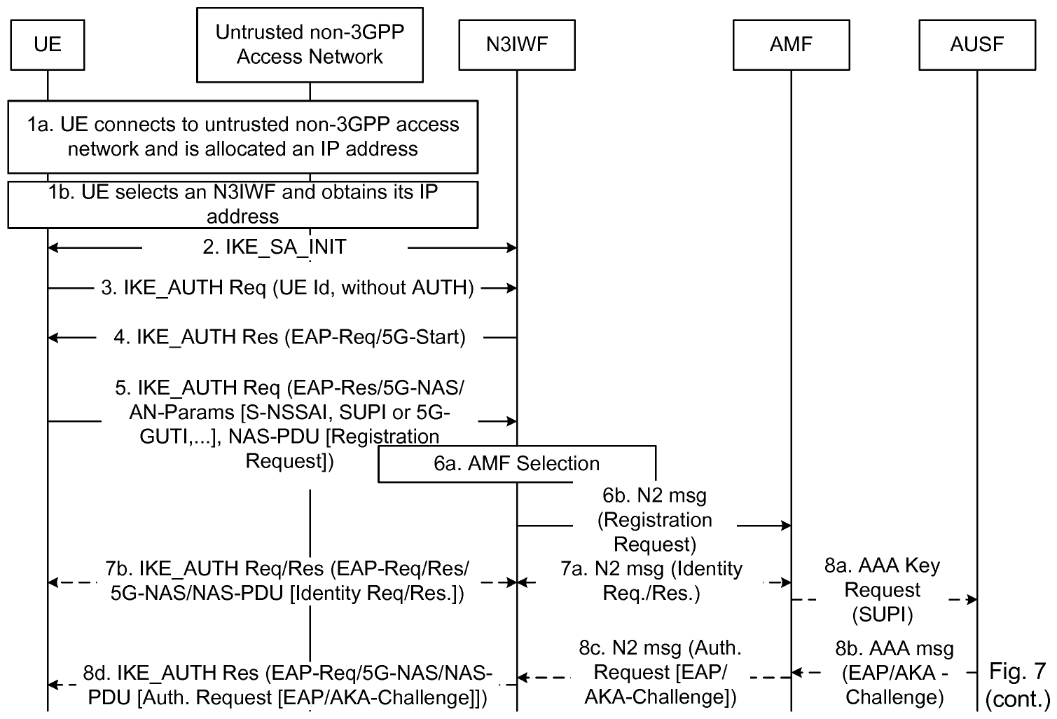

FIG. 7 illustrates the application of improved security in authorization for registration via an untrusted non-3GPP access.

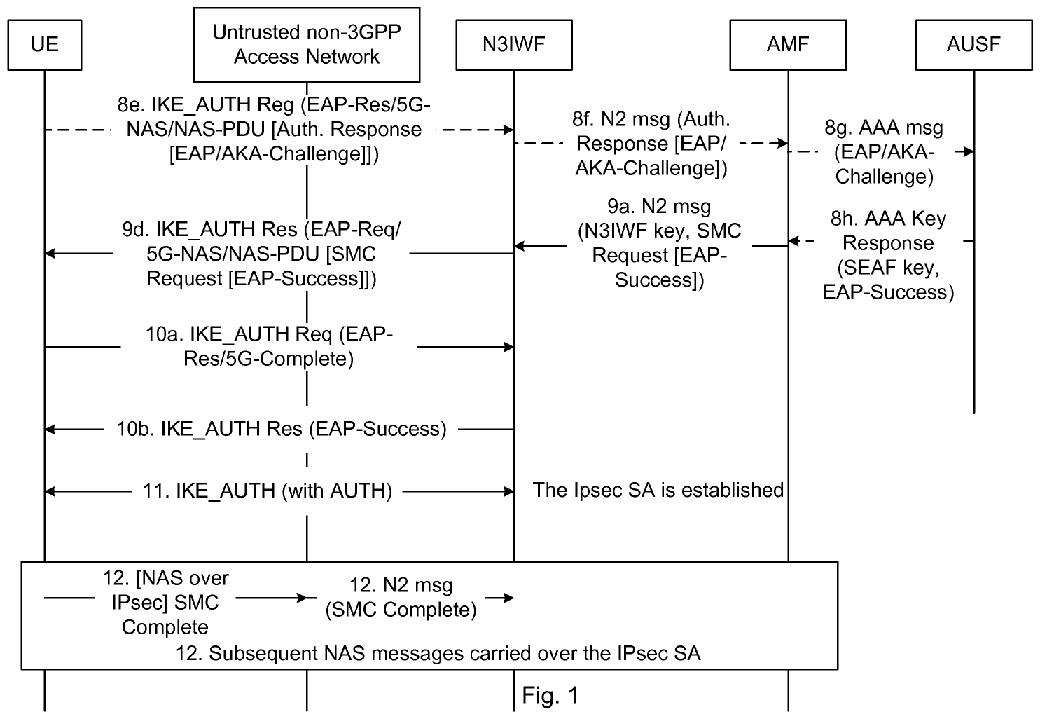

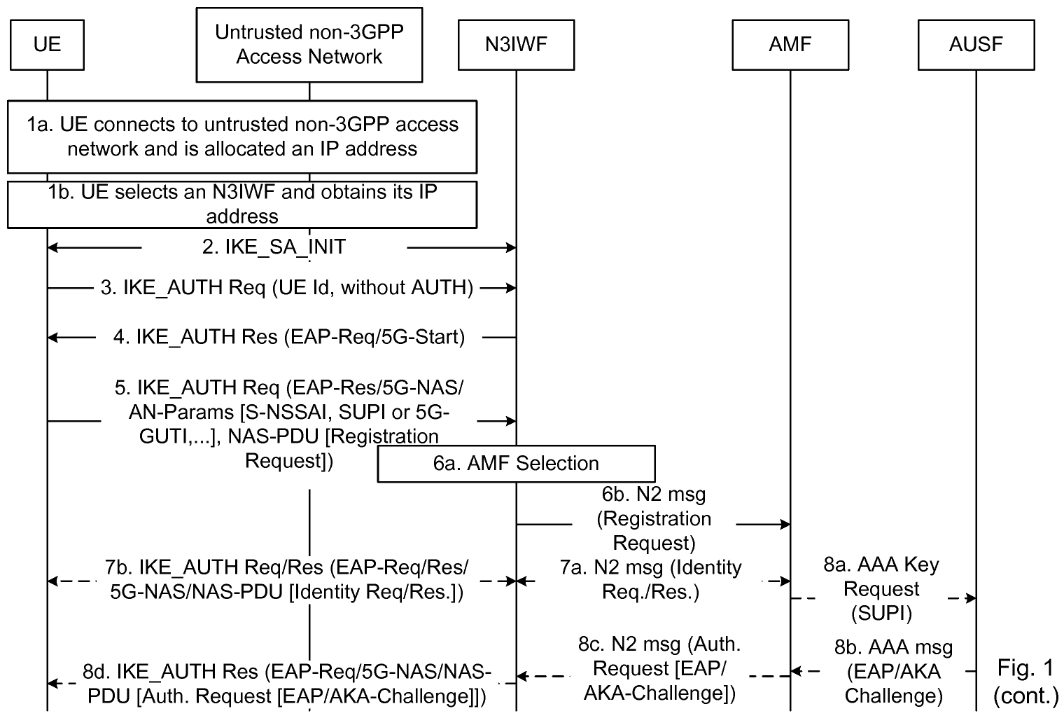

1. Steps 1-7 are as described in the baseline illustrated in FIG. 1.

8. The AMF may decide to authenticate the UE. In this case, the AMF shall select an AUSF as specified in TS 23.501 clause 6.3.4 by using the SUPI or the encrypted SUPI of the UE, and shall send a key request to the selected AUSF. The AUSF may initiate an EAP-AKA′ authentication as specified in TS 33.501. The EAP-AKA′ packets are encapsulated within NAS authentication messages and the NAS authentication messages are encapsulated within EAP/5G-NAS packets. After the successful authentication:
In step 8h, the AUSF shall send the anchor key (SEAF key) to AMF which is used by AMF to derive NAS security keys and a security key for N3IWF (N3IWF key). The UE also derives the anchor key (SEAF key) and from that key it derives the NAS security keys and the security key for N3IWF (N3IWF key).
In step 8h, the AUSF shall also include the SUPI (unencrypted), if in step 8a the AMF provided to AUSF an encrypted SUPI.

Only EAP-AKA′ is however supported for the authentication of UE via non-3GPP access, as specified in TS 33.501.

9. The AMF shall send a Security Mode Command (SMC) request to UE in order to activate NAS security. This request is first sent to N3IWF (within an N2 message) together with the N3IWF key. If an EAP-AKA′ authentication was successfully executed in step 8, then in step 9a the AMF shall encapsulate the EAP-Success received from AUSF within the SMC Request message.

10a. The UE completes the EAP-AKA′ authentication (if initiated in step 8) and creates a NAS security context and an N3IWF key. After the N3IWF key is created in the UE, the UE shall request the completion of the EAP-5G session by sending an EAP-Response/5G-Complete packet.

10b. EAP-Response/5G-Complete packet triggers the N3IWF to send an EAP-Success to UE, assuming the N3IWF has also received the N3IWF key from AMF. After sending an EAP-Success to UE, the EAP-5G layer in N3IWF derives K_{sec} as follows: K_{sec}=KDF (K_{N3IWF}, “EAP-5G”) and sends the derived K_{sec} key to the lower layer (IKEv2). This completes the EAP-5G session and no further EAP-5G packets are exchanged. If the N3IWF has not received the N3IWF key from AMF, the N3IWF shall respond with an EAP-Failure.

10c. After receiving an EAP-Success packet, the UE derives K_{sec} similarly as the N3IWF did and forwards the K_{sec} key (received from NAS layer) to the lo lower layer (IKEv2).

11. The IPsec SA is established between the UE and N3IWF by using the common K_{sec} key that was created in the UE and in the N3IWF in step 10b. This IPsec SA is referred to as the “signalling IPsec SA”. After the establishment of the signalling IPsec SA all NAS messages between the UE and N3IWF are exchanged via this SA. The signalling IPsec SA shall be configured to operate in transport mode. The SPI value is used to determine if an IPsec packet carries a NAS message or not.

It is however for further study if GRE or any other protocol is needed for the encapsulation of NAS messages.

12. The UE shall send the SMC Complete message over the established signalling IPsec SA and all subsequent NAS messages (as specified in clause 4.2.2.2.2) are exchanged between the UE and AMF via this IPsec SA.

It can be noted that the previous description includes the case that the AMF does not initiate EAP-AKA′ authentication, i.e. step 8 with all its sub-steps 8a-8h and sending EAP Success in steps 9a and 9b are conditional to AMF's decision. In that case an N3IWF key is derived from the AMF key existing in AMF. Therefore, the presented solution also applies to cases where the inner EAP process is not run.

An outer authentication process that does not produce keys as a side-effect of its authentication run is presented, with the outer process carrying an inner authentication process, with the inner process providing keying material as a result of its authentication run, and providing a derivation of the inner process's keying material as a result of the outer process.

The derivation may be a hash function of the inner process's keying material and possibly some other material (e.g. constant strings or some parameter from the outer process).

The presented solution is particularly useful for non-3gpp access in 5g.

A method, according to an embodiment, for secure authentication in a communication network is presented with reference to FIG. 7. The method is performed in a UE and comprises receiving a EAP success message from a N3IWF, thereafter deriving K_{sec}=KDF(K_{N3IWF}, “EAP-5G”), and sending the derived K_{sec} key to a lower layer.

A method, according to an embodiment, for secure authentication in a communication network is presented with reference to FIG. 7. The method is performed in a N3IWF and comprises sending a EAP success message to a UE, thereafter deriving K_{sec}=KDF(K_{N3IWF}, “EAP-5G”), and sending the derived K_{sec} key to a lower layer.

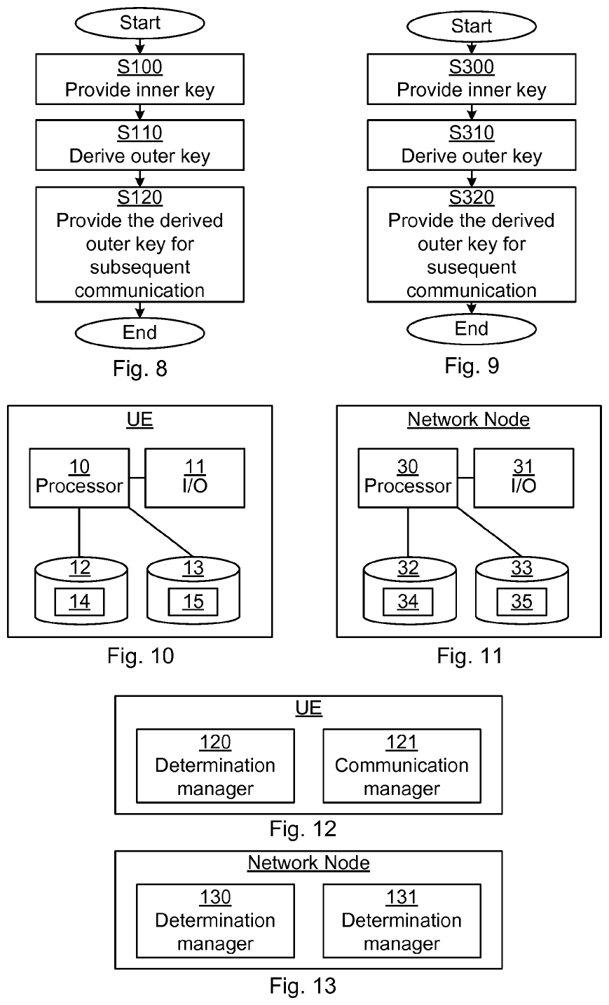

A method, according to an embodiment, for secure authentication in a communication network is presented with reference to FIG. 8. The method is performed in a user equipment, UE, and comprises providing S100 an inner authentication key by an inner authentication process, deriving S110 an outer authentication key by an outer authentication process, based on the inner authentication key, wherein the outer authentication key differs from the inner authentication key, and providing S120 the derived outer authentication key to a security protocol/for subsequent, secure communication.

The outer authentication process may be an Extensible Authentication Protocol, EAP, process, such as EAP-5G, and the inner authentication process may be an EAP process, such as EAP-Authentication and Key Agreement, AKA, or EAP-AKA′.

The outer authentication process may be EAP-5G and the inner authentication process may be integrity protected message, such as a Non-Access Stratum, NAS, message.

The deriving step may be performed with a hash function of the inner authentication key or a derivative of the inner authentication key. The hash function may use the inner authentication key and other material. The other material may be a string or a freshness parameter, such as a counter or a nonce.

The outer authentication process may rely on a key solely from the inner authentication process.

FIG. 10 is a schematic diagram showing some components of the UE. The processor 10 may be provided using any combination of one or more of a suitable central processing unit, CPU, multiprocessor, microcontroller, digital signal processor, DSP, application specific integrated circuit etc., capable of executing software instructions of a computer program 14 stored in a memory. The memory can thus be considered to be or form part of the computer program product 12. The processor 10 may be configured to execute methods described herein with reference to FIG. 8.

The memory may be any combination of read and write memory, RAM, and read only memory, ROM. The memory may also comprise persistent storage, which, for example, can be any single one or combination of magnetic memory, optical memory, solid state memory or even remotely mounted memory.

A second computer program product 13 in the form of a data memory may also be provided, e.g. for reading and/or storing data during execution of software instructions in the processor 10. The data memory can be any combination of read and write memory, RAM, and read only memory, ROM, and may also comprise persistent storage, which, for example, can be any single one or combination of magnetic memory, optical memory, solid state memory or even remotely mounted memory. The data memory may e.g. hold other software instructions 15, to improve functionality for the UE.

The UE may further comprise an input/output (I/O) interface 11 including e.g. a user interface. The UE may further comprise a receiver configured to receive signalling from other nodes, and a transmitter configured to transmit signalling to other nodes (not illustrated). Other components of the UE are omitted in order not to obscure the concepts presented herein.

FIG. 12 is a schematic diagram showing functional blocks of the UE. The modules may be implemented as only software instructions such as a computer program executing in the cache server or only hardware, such as application specific integrated circuits, field programmable gate arrays, discrete logical components, transceivers, etc. or as a combination thereof. In an alternative embodiment, some of the functional blocks may be implemented by software and other by hardware. The modules correspond to the steps in the methods illustrated in FIG. 8, comprising a determination manager unit 120 and a communication manager unit 121. In the embodiments where one or more of the modules are implemented by a computer program, it shall be understood that these modules do not necessarily correspond to process modules, but can be written as instructions according to a programming language in which they would be implemented, since some programming languages do not typically contain process modules.

The determination manager 120 is for secure authentication in a communication network. This module corresponds to the provide step S100 and the derive step S110 of FIG. 8. This module can e.g. be implemented by the processor 10 of FIG. 10, when running the computer program.

The communication manager 121 is for secure authentication in the communication network. This module corresponds to the provide step S120 of FIG. 8. This module can e.g. be implemented by the processor to of FIG. 10, when running the computer program.

A method, according to an embodiment, for secure authentication in a communication network, is presented with reference to FIG. 9. The method is performed in a network node and comprises providing S300 an inner authentication key by an inner authentication process, deriving S310 an outer authentication key by an outer authentication process, based on the inner to authentication key, wherein the outer authentication key differs from the inner authentication key, and providing S320 the derived outer authentication key to a security protocol/for subsequent, secure communication.

The outer authentication process may be an EAP process, such as EAP-5G, and the inner authentication process may be an EAP process, such as EAP-AKA, or EAP-AKA′.

The outer authentication process may be an EAP process, such as EAP-5G, and the inner authentication process may be an integrity protected message, such as a NAS message.

The deriving step may be performed with a hash function of the inner authentication key or a derivative of the inner authentication key. The hash function may use the inner authentication key and other material. The other material may be a string or a freshness parameter, such as a counter or a nonce.

The outer authentication process may rely on a key solely from the inner authentication process.

The network node may be authentication management function, AMF,/security anchor function, SEAF, or Non-3GPP Interworking Function, N3IWF, or Authentication Server Function, AUSF, or gNodeB.

FIG. 11 is a schematic diagram showing some components of the network node. The processor 30 may be provided using any combination of one or more of a suitable central processing unit, CPU, multiprocessor, microcontroller, digital signal processor, DSP, application specific integrated circuit etc., capable of executing software instructions of a computer program 34 stored in a memory. The memory can thus be considered to be or form part of the computer program product 32. The processor 30 may be configured to execute methods described herein with reference to FIG. 9.

The memory may be any combination of read and write memory, RAM, and read only memory, ROM. The memory may also comprise persistent storage, which, for example, can be any single one or combination of magnetic memory, optical memory, solid state memory or even remotely mounted memory.

A second computer program product 33 in the form of a data memory may also be provided, e.g. for reading and/or storing data during execution of software instructions in the processor 30. The data memory can be any combination of read and write memory, RAM, and read only memory, ROM, and may also comprise persistent storage, which, for example, can be any single one or combination of magnetic memory, optical memory, solid state memory or even remotely mounted memory. The data memory may e.g. hold other software instructions 35, to improve functionality for the network node.

The network node may further comprise an input/output (I/O) interface 31 including e.g. a user interface. The network node may further comprise a receiver configured to receive signalling from other nodes, and a transmitter configured to transmit signalling to other nodes (not illustrated). Other components of the network node are omitted in order not to obscure the concepts presented herein.

FIG. 13 is a schematic diagram showing functional blocks of the network node. The modules may be implemented as only software instructions such as a computer program executing in the cache server or only hardware, such as application specific integrated circuits, field programmable gate arrays, discrete logical components, transceivers, etc. or as a combination thereof. In an alternative embodiment, some of the functional blocks may be implemented by software and other by hardware. The modules correspond to the steps in the methods illustrated in FIG. 9, comprising a determination manager unit 130 and a communication manager unit 131. In the embodiments where one or more of the modules are implemented by a computer program, it shall be understood that these modules do not necessarily correspond to process modules, but can be written as instructions to according to a programming language in which they would be implemented, since some programming languages do not typically contain process modules.

The determination manager 130 is for secure authentication in a communication network. This module corresponds to the provide step S300 and the derive step S310 of FIG. 9. This module can e.g. be implemented by the processor 30 of FIG. 11, when running the computer program.

The communication manager 131 is for secure authentication in the communication network. This module corresponds to the provide step S320 of FIG. 9. This module can e.g. be implemented by the processor 30 of FIG. 13, when running the computer program.

A method, according to an embodiment, for secure authentication in a communication network is presented with reference to FIG. 9. The method is performed in a 5G core, SGC, network, and comprises providing S300 an inner authentication key by an inner authentication process in authentication management function, AMF/security anchor function, SEAF, deriving S310 an outer authentication key by an outer authentication process in Non-3GPP Interworking Function, N3IWF, based on the inner authentication key provided in AMF/SEAF, wherein the outer authentication key differs from the inner authentication key, and providing S320 the derived outer authentication key to a security protocol/for subsequent, secure communication.

The invention has mainly been described above with reference to a few embodiments. However, as is readily appreciated by a person skilled in the art, other embodiments than the ones disclosed above are equally possible within the scope of the invention, as defined by the appended claims.

1. A method for secure authentication in a communication network, the method being performed in a user equipment, UE, and comprising:
providing an inner authentication key by an Extensible Authentication Protocol, Authentication and Key Agreement, EAP-AKA′;
deriving an outer authentication key by an EAP-5G process, based on the inner authentication key, wherein the outer authentication key differs from the inner authentication key; and
providing the derived outer authentication key to a security protocol/for subsequent, secure communication.

2.-3. (canceled)

4. The method according to claim 1, wherein the deriving is performed with a hash function of the inner authentication key or a derivative of the inner authentication key.

5. The method according to claim 4, wherein the hash function uses the inner authentication key and other material.

6. The method according to claim 5, wherein the other material is a string or a freshness parameter, such as a counter or a nonce.

7. The method according to 1, wherein the outer authentication process relies on a key solely from the inner authentication process.

8.-15. (canceled)

16. A method for secure authentication in a communication network, the method being performed in a 5G core, 5GC, network, and comprising:
providing an inner authentication key by an Extensible Authentication Protocol, Authentication and Key Agreement, EAP-AKA′ process in authentication management function, AMF/security anchor function, SEAF;
deriving an outer authentication key by an EAP-5G process in Non-3GPP Interworking Function, N3IWF, based on the inner authentication key provided in AMF/SEAF, wherein the outer authentication key differs from the inner authentication key; and
providing the derived outer authentication key to a security protocol/for subsequent, secure communication.

17. A user equipment, UE, for secure authentication in a communication network, the UE comprising:
a processor; and
a computer program product storing instructions that, when executed by the processor, causes the UE to:
provide an inner authentication key by an Extensible Authentication Protocol, Authentication and Key Agreement, EAP-AKA, or EAP-AKA′ process;
derive an outer authentication key by an EAP-5G process, based on the inner authentication key, wherein the outer authentication key differs from the inner authentication key; and
provide the derived outer authentication key to a security protocol/for subsequent, secure communication.

18.-19. (canceled)

20. The UE according to claim 17, wherein the derive is performed with a hash function of the inner authentication key or a derivative of the inner authentication key.

21. The UE according to claim 20, wherein the hash function uses the inner authentication key and other material.

22. The UE according to claim 21, wherein the other material is a string or a freshness parameter, such as a counter or a nonce.

23. The UE according to claim 17, wherein the outer authentication process relies on a key solely from the inner authentication process.

24.-31. (canceled)

32. A 5G core, 5GC, network for secure authentication in a communication network, the 5GC network comprising:
a processor; and
a computer program product storing instructions that, when executed by the processor, causes the 5GC network to:
provide an inner authentication key by an Extensible Authentication Protocol, Authentication and Key Agreement, EAP-AKA′ process in authentication management function, AMF/security anchor function, SEAF;
derive an outer authentication key by an EAP-5G process in Non-3GPP Interworking Function, N3IWF, based on the inner authentication key provided in AMF/SEAF, wherein the outer authentication key differs from the inner authentication key; and
provide the derived outer authentication key to a security protocol/for subsequent, secure communication.

33.-35. (canceled)

36. A computer program for secure authentication in a communication network, the computer program comprising computer program code which, when run on a user equipment, UE, causes the UE to:
provide an inner authentication key by an Extensible Authentication Protocol, Authentication and Key Agreement, EAP-AKA′ process
derive an outer authentication key by an EAP-5G process, based on the inner authentication key, wherein the outer authentication key differs from the inner authentication key; and
provide the derived outer authentication key to a security protocol/for subsequent, secure communication.

37.-39. (canceled)
